(19) United States
(12) Patent Application Publication
(10) Pub. No.: US 2022/0333298 A1
(43) Pub. Date: Oct. 20, 2022

(54) MODIFICATION OF TEXTILE IN SELECTED AREA

(71) Applicant: POLYCORE, LLC, TUSTIN, CA (US)

(72) Inventors: ARTHUR MING JING CHEN, TUSTIN, CA (US); CHENCHUNG STEVE CHANG, ATTLEBORO, MA (US); SHU-YI CHEN, TAIPEI (TW); SYANG PENG RWEI, TAIPEI (TW)

(73) Assignee: POLYCORE, LLC, TUSTIN, CA (US)

(21) Appl. No.: 17/853,458

(22) Filed: Jun. 29, 2022

Related U.S. Application Data
(63) Continuation-in-part of application No. 16/898,025, filed on Jun. 10, 2020.
(60) Provisional application No. 62/861,932, filed on Jun. 14, 2019.

(51) Int. Cl. D06M 17/04; C09J 7/38; C09J 7/35

(52) U.S. Cl. CPC D06M 17/04; C09J 7/38; C09J 7/35

(57) ABSTRACT

A laminate for use in a process for strengthening a selected area of a raw textile or manufactured textile product to enhance properties and performance. The process comprising the steps of applying a laminate trimmed to match the selected. area, then placed on the textile and heated in a hot press. The laminate can be comprised of a polymer film and a nonsolvent adhesive. The polymer film can be tailored from a blend of hard acrylic and tough poly-urethane to adjust for rigidity and strength. The adhesive can he a hot melt or pressure sensitive types as well as any type that provides a secure adhesion.

### BACKGROUND OF THE INVENTION

This application is a divisional application of co-pending U.S. Nonprovisional Application No. 16/898,025 tiled on Jun. 10, 2020, which claims the benefit of

Provisional Application No. 62/861,932 filed on Jun. 14, 2019.

### TECHNICAL FIELD OF THE INVENTION

The present invention relates to woven textiles, and more particularly to a process to improve the performance and properties of textile fabrics.

### DESCRIPTION OF THE RELATED ART

Woven textiles have provided protection from elements and carried everything we depend on. In order to improve the properties and performance of textiles, many innovations have been developed. There are specialty threads and yams as well as weave patterns for improved strength. Many types of coating are also available to improve fabric strength, and to provide stain and water resistance.

Modified textiles or coating might affect appearance, increase stiffness and change tactile sensitivity, affecting the intention of a garment design. Locally enhancing a fabric by stitching additional fabric, a patch, to a selected area is commonly employed. However, the patch will impact the aesthetic of the garment and has proven not to increase the fabric performance by much.

Demands to improve the performance of textile fabric have driven many innovations through the history. There are many types of coating invented and engineered to enhance fabrics. Fabric type and weight have been expanded to provide strength, abrasion, water and stain resistance, flexibility, air and moisture permeability. Some of the common solutions for attaining the usual desired properties are listed below in Table 1.

TABLE 1

| Property | Solutions |
|---|---|
| Strength (tensile, | Fabric weight, Yarn type, Rubberized |
| tear, puncture) | coating, Polymer coating |
| Abrasion | Fabric weight, Yarn modification, |
| | Coating of polymers; Silicone coating |
| Water/Stain Repellent | Waterproof coating; Silicone |
| | coating; Fluoride coating |
| Breathability (Moisture | Specialty coating to control air |
| Permeability) | permeability |

One of the desirable properties for textile to improve upon is abrasion resistance. The abrasion force exerted on textile stretches the yarns causing them to slip and cut themselves. The repeating damages accumulate and cause eventual yarn breakage. There are standardized abrasion test methods (e.g. ASTM D4966 Standard Test Method for Abrasion Resistance of Textile Fabrics (Martindale Abrasion Tester Method)) which simulate the abrasion actions in a controlled laboratory condition to evaluate the performance of textile.

Coating enhances abrasion resistance by bonding individual yarns with a polymeric compound. binding compound should be tough and resistant to cracking and adhere to the yarns. It is also desirable to maintain the flexibility of coated fabric so as not to affect the tactile behavior. Polyurethane has the ability of being able to be tailored to be rigid

Of malleable and is thus the compound of choice. For a lightweight fabric, a more malleable polyurethane film might be preferred to provide more flexible coating. However, coating also causes the most apparent changes in the appearance and supple nature of textile materials.

There is a need for a process that would provide garment designers an option to enhance textiles in select areas while meeting eco-friendliness with the least possible impact in the garment manufacturer process flow. Further, the needed process would increase fabric performance and would not affect the aesthetic of textile materials and completed textile products. Moreover, the needed process would provide enhanced abrasion resistance for areas of a textile product, i.e., a garment, luggage, or other textile product that may be subject to more than the usual wear and tear.

### SUMMARY OF THE INVENTION

To minimize the limitations found in the prior art, and to minimize other limitations that will he apparent upon the reading of the specifications, the present invention provides a process for modifying a select area of a textile to increase its properties and performance. This is accomplished by customizing a laminate to a select area of a textile or textile product and applying the laminate thereon. The laminate may be comprised of a film with an adhesive application. The laminate may also be comprised of a cured adhesive capable of providing enough yarn binding to enhance the fabric properties to the desirable level. Heat and/or pressure can be applied with a garment hot press to activate the laminate so that the adhesive flows into the textile. Application of the laminated film on the fabric can be carried out prior, during or after the textile product manufacturing process.

A process in accordance with the invention, in which an adhesive which requires no solvent to activate is combined with a film customized in the shape of a selected area on a. fabric. The film is laminated with an application of the adhesive. The film thus laminated when applied to a textile will enhance the properties and appearance of the fabric to meet a user's expectations. Areas of a fabric selected for enhancement, include areas likely to wear out, such as the elbow area of a garment or the bottom of a backpack.

A process in accordance with the invention, in which a polymer film is applied to selected areas to enhance the properties and performance of textiles locally when used in textile products like garments and containers such as backpacks and luggage. The film can be tailored from a blend of hard acrylic and tough polyurethane to adjust the rigidity and strength. The adhesive used to laminate the film to fabric can be hot melt or pressure sensitive types as well as any type that provides a. secure adhesion. The film or film/adhesion laminate can be embossed or die cut to provide a better flow with the textile when the flexibility is of concern.

Hot melt adhesives (HMA) or pressure sensitive adhesives (PSA) are developed to avoid volatile solvent in the conventional lamination process to coat fabrics. In the current invention an HMA or PSA is laminated to the films to provide the desirable physical and mechanical properties.

The film/adhesive laminate can be die cut or laser sliced to shape as preforms. The shape of a preform matches the area on the textile product to be enhanced. The film/adhesive preforms are placed on the area to be enhanced.

It is further possible to modify the film to provide different surface finishes to either highlight (such as reflective appearance) or a muted low-key appearance. The film can be die cut into sections or mesh to enhance flexibility to better flow with the movement of the fabric. Branding with printed logo or trademarks can be applied on the film.

A cured adhesive can also be used without a film to provide enough yam binding to enhance fabric properties to a desirable level.

One objective of the invention is to provide a selected area strengthening process to enhance tensile, tear and puncture strength, abrasion resistance, water and stain repellency, flexibility, breathability, and moisture permeability.

Another objective of the invention is to provide a process that can be performed before, during or after the manufacturing process.

A third objective of the invention is to provide a simple process that would not affect the aesthetic of a finished textile product.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a polyurethane film and adhesive individually laminated to a fabric according to the invention.

FIG. 2 shows a film and adhesive pre-laminated and then applied to a fabric in accordance with the invention.

FIG. 3 shows selected area strengthening of laminated film on a fabric in accordance with the invention.

### DETAILED DESCRIPTION OF THE PREFERRED EMBODIMENTS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below

The present invention comprises a selected area strengthening (“SAS”) process using a film and an adhesive for treatment of textiles or fabrics to enhance properties and performance. Fabric samples were treated with the process and then tested for tensile, tear and abrasion strength. The film and adhesive used in the process were applied either individually, without lamination or were pre-laminated prior to being applied to the samples. The results were compared to the as-received conditions of the samples to establish the effectiveness of the invented process.

The testing standards applied are listed below in Table 2. The values of peel strength of a polyurethane film are reported as the tensile breaking load of laminated polyurethane film on an SAS treated film.

TABLE 2

| Properties (unit) | Testing Standards |
|---|---|
| Tensile Strength | ASTM D5034 |
| | Standard Test Method for Breaking Strength |
| | and Elongation of Textile Fabrics (Grab Test) |
| Tear Strength | ASTM D2261 |
| | Standard Test Method for Tearing Strength of |
| | Fabrics by the Tongue (Single Rip) Procedure |
| | (Constant-Rate-of-Extension Tensile Testing Machine) |
| Abrasion | ASTM D4966 |
| (Martindale) | Standard Test Method for Abrasion Resistance of |
| (12 kPa/320 Cw sandpaper) | Textile Fabrics (Martindale Abrasion Tester Method) |
| Abrasion (Taber) | ASTM D3389 |
| (1000 g/CS10 cycle) | Standard Test Method for Coated Fabrics Abrasion |
| | Resistance (Rotary Platform Abrader) |
| Peeling strength | AATCC 136 (ASTM D2724) |
| | Bond Strength of Bonded and Laminated Fabrics |

### EXAMPLE 1

### Individual Film and Thermal Adhesive

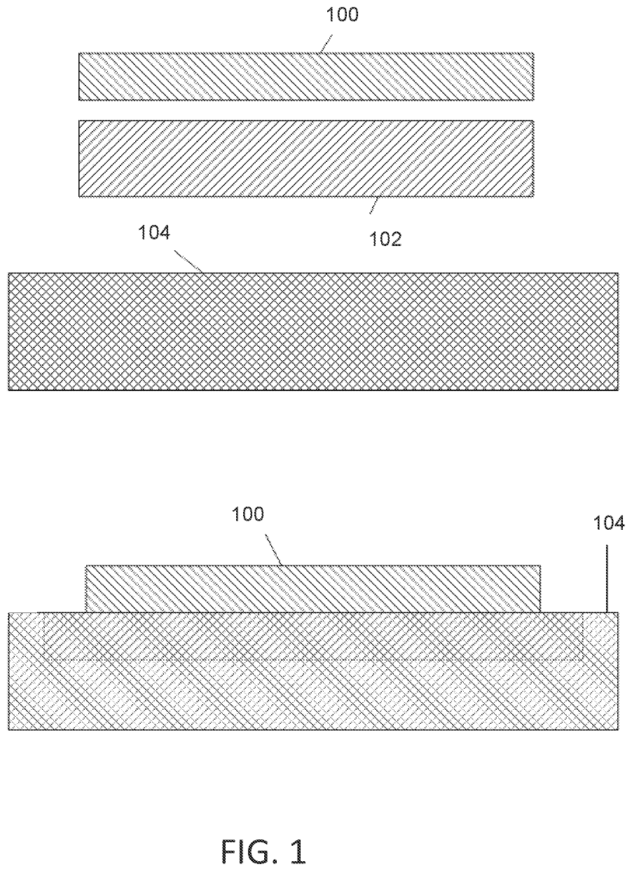

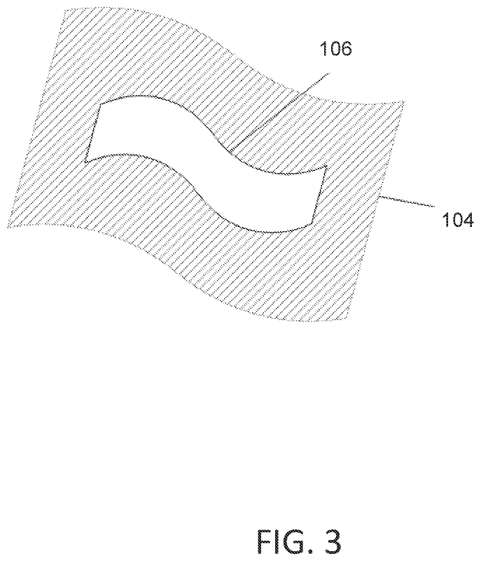

A sheet of 0.03 mm thick polyurethane (PU) film 100 was layered to a sheet of 0.7 mm thick thermal adhesive 102 and were cut to size. The polyurethane/thermal adhesive layup 106 was placed on a sample fabric of 210D weight, of nylon, polyester and elastane blend as shown in FIG. 3. The polyurethane 100/thermal adhesive 102/textile 104 layup was placed in a garment hot press and heated to 130° C. for 30 seconds to laminate the layup (see FIG. 1). Test results comparing as-received and SAS laminated samples are shown below in Table 3.

TABLE 3
Properties of Polyurethane Film Laminated to 210D Blended

| | 210D | | | |
|---|---|---|---|---|
| | 75% Nylon-15% Polyester-10% Elastane | | | |
| | As-Received | | SAS | |
| | Warp | Weft | Warp | Weft |
| Tensile Strength | 33.7 | 80.5 | 46.1 | 102.5 |
| Tear Strength | 6 | 7.6 | 7.2 | 10.9 |
| Abrasion (Martindale, | 30 | | 350 | |
| 12 kPa/320 Cw sandpaper) | | | | |
| Abrasion (Taber, | 1000 | | 5000 | |
| 1000 g/CS10 cycle) | | | | |
| Peel Strength, lbf | — | — | 13+ | 15+ |

The tensile and tear strength show slight improvement after the lamination while the abrasion strength shows several folds increase. The peel strength is reported as the force when the film ruptured and is comparable to that for the film tensile strength. The peel strength indicated that the adhesion of film was as strong as the film itself.

### EXAMPLE 2

### Laminated Polyurethane Film and Thermal Adhesive on Polyester Fabric

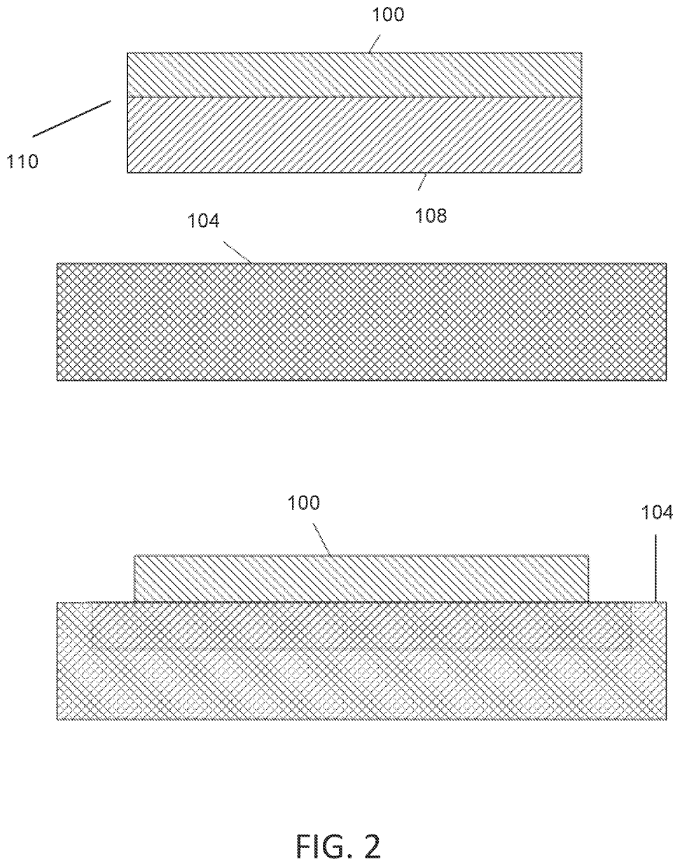

A 0.03 mm thick polyurethane film 100 was roller laminated to a 0.12 mm thick hot melt adhesive (HMA) 108 to form a laminate 110 of PU/HMA. This laminate was cut to shape and laid on top of various weights and types of textile in a garment hot press set at 130° C. for 30 seconds (see FIG. 2). Thermal laminated film/adhesive/textile sheets were examined, and results are presented below in Tables 4 and 5, in which the test results from as-received textiles are included for comparison.

TABLE 4
Laminated Polyurethane/Hot Melt Film on 300D Polyester

| | As-Received | | SAS | |
|---|---|---|---|---|
| 300D Polyester | Warp | Weft | Warp | Weft |
| Tensile strength, lbf | 329 | 241 | 342+ | 234+ |
| Tear strength, lbf | 15.3 | 12.8 | 11+ | 8+ |
| Abrasion (Martindale, | 40 | | 900 | |
| 12 kPa/320 grit sandpaper) | | | | |
| Abrasion (Taber, | 2000 | | 5000 | |
| 1 Kg/CS10) cycles | | | | |
| Peel strength, lbf | — | — | 17+ | 17+ |

TABLE 5
Laminated Polyurethane/Hot Melt Film on 600D Polyester

| | As-Received | | SAS | |
|---|---|---|---|---|
| 600D Polyester | Warp | Weft | Warp | Weft |
| Tensile strength, lbf | 242 | 281 | 271+ | 345+ |
| Tear strength, lbf | 22.5 | 25.7 | 16+ | 17+ |
| Abrasion (Martindale, | 110 | | 1150 | |
| 12 kPa/320 grit sandpaper) | | | | |
| Abrasion (Taber, | 1000 | | 5000 | |
| 1 Kg/H18) cycles | | | | |
| Peel strength, lbf | — | — | 22+ | 22+ |

Fabrics treated with roller pre-laminated PU film/MA showed improve tensile and tear strength. The abrasion resistance of fabric treated with PU/HMA laminate showed several orders of increase. The peel strength of PU/HMA laminate on fabric was very close to the tensile strength of PU film. This indicates the adhesion of laminate was as strong as the PU film.

### EXAMPLE 3

### Laminated Polyurethane Film and Thermal Adhesive on Nylon Fabrics

A 0.03 mm thick polyurethane film was roller laminated to a 0.12 mm thick hot melt adhesive (HMA) to form a laminate of PU/HMA. This laminate was cut to shape and laid on top of various weights of nylon-based textile and placed in a garment hot press set at 130° C. for 30 seconds. Thermal laminated film/adhesive/textile sheets were examined, and results are presented below in Tables 6 to 9, in which the test results from as-received textiles are included for comparison.

TABLE 6
Laminated Polyurethane/Hot Melt Film on 70D Nylon

| | As-Received | | SAS | |
|---|---|---|---|---|
| 70D Nylon | Warp | Weft | Warp | Weft |
| Tensile Strength, lbf | 88.8 | 70.4 | 76.4+ | 63.2+ |
| Tear Strength, lbf | 4.2 | 4 | 5.8+ | 5+ |
| Abrasion (Martindale, | 10 | | 250 | |
| 12 kPa/320 grit sandpaper) | | | | |
| Abrasion (Taber, | 17 | | 100 | |
| 1 Kg/H18) cycles | | | | |
| Peel Strength, lbf | — | — | 6+ | 5+ |

TABLE 7
Laminated Polyurethane/Hot Melt Film on 210D Nylon

| | |
|---|---|
| As-Received | SAS |

| 210D Nylon | Warp | Weft | Warp | Weft |
|---|---|---|---|---|
| Tensile Strength, lbf | 232.6 | 183.9 | 243+ | 197+ |
| Tear Strength, lbf | 16.3 | 12.6 | 9+ | 64+ |

| | | |
|---|---|---|
| Abrasion (Martindale, | 65 | 290 |
| 12 kPa/320 grit sandpaper) | | |
| Abrasion (Taber, | 50 | 3500 |
| 1 Kg/H18) cycles | | |

| | | | | |
|---|---|---|---|---|
| Peel Strength, lbf | — | — | 14+ | 12+ |

TABLE 8
Laminated Polyurethane/Hot Melt Adhesive Film on 500D Nylon

| | As-Received | | SAS | |
|---|---|---|---|---|
| 500D Nylon | Warp | Weft | Warp | Weft |
| Tensile Strength, lbf | 224.4 | 147.2 | 313+ | 285+ |
| Tear Strength, lbf | 24.5 | 24 | 13+ | 11+ |
| Abrasion (Martindale, | 65 | | 620 | |
| 12 kPa/320 grit sandpaper) | | | | |
| Abrasion (Taber, | 100 | | 4000 | |
| 1 Kg/H18) cycles | | | | |
| Peel Strength, lbf | — | — | 24+ | 19+ |

TABLE 9
Laminated Polyurethane/Hot Melt Adhesive Film on 1000D Nylon

| | As-Received | | SAS | |
|---|---|---|---|---|
| 1000D Nylon | Warp | Weft | Warp | Weft |
| Tensile Strength, lbf | 458.5 | 395.9 | 452+ | 394+ |
| Tear Strength, lbf | 43.7 | 38.8 | 26+ | 22+ |
| Abrasion (Martindale, | 100 | | 1650 | |
| 12 kPa/320 grit sandpaper) | | | | |
| Abrasion (Taber, | 300 | | 3500 | |
| 1 Kg/H18) cycles | | | | |
| Peel Strength, lbf | — | 16+ | — | 13+ |

Fabrics treated with roller pre-laminated PU film/HMA showed improved tensile and tear strength. In the case of tensile strength for the lightweight 70D Nylon, it reduced slightly albeit the values are within the test variation ranges. The abrasion resistance of fabric treated with PU/HMA laminate showed several orders of increase. The peel strength of PU/HMA laminate on fabric was very close to the tensile strength of PU film. This indicates the adhesion of laminate was as strong as the PU film.

Example 4

### Laminated Polyurethane Film/Hot Melt Adhesive on Nylon/Polyester Blended Fabric

A 0.03 mm thick polyurethane film was roller laminated to a 0.12 mm thick hot melt adhesive (HMA) to form a laminate of PU/HMA. This laminate was cut to shape and laid on top of a nylon/polyester based blend textile in a garment hot press set at 130° C. for 30 seconds. Thermal laminated film/adhesive/textile sheets were examined, and results are presented blow in Table 10, in which the test results from as-received textiles are included for comparison.

TABLE 10
Laminated Polyurethane/Hot Melt Adhesive Film on 300D Blend

| | 300D | | | |
|---|---|---|---|---|
| | 75% Nylon-15% Polyester-10% Elastane | | | |
| | As-Received | | SAS | |
| | Warp | Weft | Warp | Weft |
| Tensile Strength, lbf | 132 | 143.2 | 149.9 | 148.6 |
| Tear Strength, lbf | 5.7 | 9.8 | 5.7 | 8 |
| Abrasion (Martindale, | 10 | | 250 | |
| 12 kPa/320 grit sandpaper) | | | | |
| Abrasion (Taber, | 1000 | | 5000 | |
| 1 Kg/CS10) cycles | | | | |
| Peel Strength, lbf | — | — | 13+ | 15+ |

Fabrics treated with roller pre-laminated PU film/HMA show improved tensile and tear strength. The abrasion resistance of fabric treated with PU/HMA laminate showed several orders of increase. The peel strength of PU/HMA laminate on fabric was very close to the tensile strength of PU film. This indicates the adhesion of laminate was as strong as the PU film.

The flexibility of lamination performance enhancing film and the choice of adhesive at the critical area allows textile application to increase its expected service life and maintain the aesthetic appeal. The film and adhesive can be applied in pre-laminated manner to ensure a better adhesion. Applying the film without pre-laminated adhesive though provides the flexibility to select film and adhesive to meet the application demands,

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is clamed is

1. A laminate for use in a process for strengthening a select area of a textile,
wherein the laminate is trimmed to match the size and shape of at least one selected area of the textile,
wherein the laminate is laid on the corresponding selected area of the textile in a heat press set at 130 degrees Celsius for 30 seconds, and
wherein the laminate can be a polymer film laminated to a nonsolvent adhesive.

2. The laminate according to claim 1, wherein the polymer film can be chosen from a blend of acrylic and polyurethane to adjust the rigidity and strength of the textile.

3. The laminate according to claim 1. wherein the polymer film has at least one printable surface for branding.

4. The laminate according to claim 1. wherein the adhesive can be a thermal adhesive, a hot melt adhesive, a pressure sensitive adhesive, or any type that provides a secure adhesion.
